(19) United States
(12) Patent Application Publication
(10) Pub. No.: US 2015/0357173 A1
(43) Pub. Date: Dec. 10, 2015

(54) LASER ABLATION ATMOSPHERIC PRESSURE IONIZATION MASS SPECTROMETRY

(71) Applicant: WESTFÄLISCHE WILHELMS-UNIVERSITÄT MÜNSTER, Münster (DE)

(72) Inventors: CHRISTINA KOEPPEN, Muenster (DE); OLGA REIFSCHNEIDER, SCHEMMERHOFEN (ALBERWEILER) (DE); CHRISTOPH ALEXANDER WEHE, BREMEN (DE); MICHAEL SPERLING, MUENSTER (DE); UWE KARST, MUENSTER (DE)

(21) Appl. No.: 14/763,522

(22) PCT Filed: Jan. 28, 2014
(86) PCT No.: PCT/EP2014/051575

§ 371 Date: Jul. 27, 2015

Related U.S. Application Data
(60) Provisional application No. 61/757,252, filed on Jan. 28, 2013.

(51) Int. Cl. H01J 49/04; H01J 49/00

(52) U.S. Cl. CPC H01J 49/0463; H01J 49/0031

(57) ABSTRACT

In an embodiment, the present invention provides an apparatus for mass spectrometry which includes a laser ablation sampler comprising a laser ablation chamber and a laser. The laser ablation chamber is configured so that the laser can irradiate and ablate a material from a sample to generate an ablated sample material. An atmospheric pressure ionization source generates an ion population. The atmospheric pressure ionization source is operatively connected to the laser ablation chamber via a transfer line so that an ablated sample material is transportable thereto. A mass spectrometer is operatively connected to the laser ablation chamber and to the atmospheric pressure ionization source. The ablated sample material interacts with the atmospheric pressure ionization source to generate an ion population having a mass-to-charge ratio distribution. The ion population is transmitted to the mass spectrometer, which provides information on a mass-to-charge ratio distribution of the ion population.

### CROSS REFERENCE TO PRIOR APPLICATIONS

Priority is claimed to U.S. Provisional Patent Application No. 61/757,252, filed Jan. 28, 2013. The entire disclosure of said application is incorporated by reference herein.

### FIELD

The present invention relates to an apparatus for performing mass spectrometry and to a method for analyzing a solid sample through mass spectrometry using the apparatus. The present invention in particular provides an apparatus capable of performing mass spectrometry under ambient conditions and mass spectrometry imaging as well as a method therefor. The apparatus consists of two subunits, a laser ablation sampler and a mass spectrometer, which are connected via an ambient/atmospheric pressure ionization source such as an atmospheric pressure chemical ionization (APCI) or an electrospray ionization (ESI) source. Laser ablation is used for sampling, providing both lateral and depth resolution, which can be chosen by driving the laser with appropriate spot size and laser energy. The mass spectrometer thereby provides molecular information for the composition of each voxel sampled by the laser ablation sampler.

### BACKGROUND

The invention relates to the mass spectrometric analysis of a surface material by means of laser ablation. The mass spectrometric analysis of a material on or in surfaces of solid bodies has many applications, ranging from imaging mass spectrometry of substance distributions in thin tissue sections, or in thin-layer chromatographic or electrophoretic plates, to the analysis of arbitrarily applied analytical samples.

The focus of attention in recent years has been on imaging mass spectrometry (IMS), particularly with high spatial resolution with the objective to analyze μm- or even sub-μm scale structures such as cell organelles.

Many different methods for sampling a surface material exist, some of which also ionize immediately. An example thereof is secondary ion mass spectrometry (SIMS) or matrix-assisted laser desorption ionization mass spectrometry (MALDI-MS). Since ions cannot be transported under atmospheric pressure over long distances, the surface sampling process of these techniques must either take place in a vacuum, or at least in close proximity to the sample entrance of the mass spectrometer. This is typically realized by constructing dedicated instruments that combine the laser sampling and the mass spectrometer, sometimes by incorporating the laser sampling process within the vacuum part of the mass spectrometer.

MALDI is in particular used as a method to remove and ionize material so as to analyze a molecular composition of surface materials. Characteristic to most of these methods is the requirement for a delicate chemical and physical sample manipulation and the need to perform the imaging experiment in a vacuum, which prevents the study of native samples. This technique requires, for example, that a matrix substance be applied to the sample surface to facilitate the desorption and ionization process of the analyte molecules. The method, which is particularly successful for thin tissue sections, furthermore requires that a relatively thick, very uniform layer of matrix material be applied, for example, by spraying as a solution of individual layers. The matrix material must be chosen to interact with the wavelength of the laser, and must be suitable to support the desorption of the target analyte molecules. A further disadvantage of the applied matrix layer is the decrease of lateral spatial resolution.

Other sampling methods, such as laser ablation, only remove the material from the surface and subsequently generate a neutral aerosol from the material being analyzed. For analysis by mass spectrometry, the sample aerosol must then be ionized by another ionization source, for example, in an inductively coupled plasma (ICP), in which the aerosol particles are transformed into element ions, thus making it possible to determine the elementary composition of the ablated sample. Using this technique for biological sample materials, such as tissue sections, provides valuable information on the elemental composition including isotopes. Unfortunately, this technique cannot determine a molecular composition since molecules do not survive the processes taking place during ionization via ICP.

Another technique, termed laser ablation electrospray ionization (LAESI), requires no sample pretreatment, can operate at atmospheric-pressure, and offers the potential of depth information. In this technique, laser ablation using a mid-IR laser removes material from a surface and ESI is used to directly ionize molecules from the ablation plume. The ionization source is here also a special construction incorporating the laser sampler.

### SUMMARY

An aspect of the present invention is to provide a system and a method which avoids the aforementioned disadvantages.

In an embodiment, the present invention provides an apparatus for mass spectrometry which includes a laser ablation sampler comprising a laser ablation chamber and a laser configured to produce a laser beam. The laser ablation chamber is configured so that the laser can irradiate and ablate a material from a sample placed within the laser ablation chamber so as to generate an ablated sample material. An atmospheric pressure ionization source is configured to generate an ion population. The atmospheric pressure ionization source is operatively connected to the laser ablation chamber via a transfer line so that an ablated sample material is transportable to the atmospheric pressure ionization source. A mass spectrometer is operatively connected to the laser ablation chamber and to the atmospheric pressure ionization source. The ablated sample material interacts with the atmospheric pressure ionization source to generate the ion population having a mass-to-charge ratio distribution. The ion population is transmitted to the mass spectrometer. The mass spectrometer provides information on the mass-to-charge ratio distribution of the ion population.

### BRIEF DESCRIPTION OF THE DRAWINGS

The present invention is described in greater detail below on the basis of embodiments and of the drawings in which:

FIG. 1 shows a schematic diagram of a laser ablation atmospheric pressure post ionization mass spectrometry (LA/API-MS) setup;

FIG. 2 shows a schematic diagram of a laser ablation atmospheric pressure chemical ionization mass spectrometry (LA/APCI-MS) setup;

FIG. 3 shows the mass spectrum of a dried droplet of a caffeine solution obtained by LA/APCI-MS measurements;

FIG. 4 shows the mass spectrum of a dried droplet of an acetaminophen solution obtained by LA/APCI-MS measurements;

FIG. 5 shows an optical image of a thin layer chromatography plate and the ion images for caffeine and for acetaminophen as MH⁺ of a thin layer chromatography plate; and

FIG. 6 shows extracted ion traces for three different tablets, a) Thomapyrin Classic (Boehringer Ingelheim Pharma GmbH & Co. KG), b) Coffeinum N 0.2 g (Mylan dura GmbH), and c) Paracetamol-ratiopharm 500 (Ratiopharm GmbH).

### DETAILED DESCRIPTION

In an embodiment, the present invention provides an apparatus for mass spectrometry comprising an atmospheric pressure ionization source/ion source, a laser ablation sampler, and a mass spectrometer in which the laser ablation sampler is operably connected with the ion source via a transfer line that allows for a transport of a generated aerosol with a gas out of the laser ablation chamber towards the ion source. The generated aerosol of the ablated sample material is then fed into the ion source which ionizes the analyte species directly dispersed within the gas. The resulting ions are then analyzed with a mass spectrometer.

The interaction of the ablated sample material with the atmospheric pressure ionization source releases and ionizes molecules from the ablated sample material so as to generate the ion population.

In an embodiment of the present invention, the atmospheric pressure ionization source can, for example, be an atmospheric pressure chemical ionization (APCI), an atmospheric pressure photoionization (APPI), an atmospheric pressure laser ionization (APLI), an electrospray ionization (ESI), or a corona-type discharge source.

Various lasers can be used for the laser ablation process of the present invention. The laser can, for example, differ in terms of the wavelength of the emitted light. In an embodiment of the present invention, the laser can, for example, operate in an ultra-violet (UV) wavelength range, an infrared (IR) wavelength wave range, and/or in a visible wavelength range. The mode of emission can, for example, be pulsed and/or continuous. In an embodiment of the present invention, the laser can, for example, comprise a pulsed mode of emission operating in a femtosecond range, a picosecond range, or in a nanosecond range. The pulse frequency can, for example, be in the range of 1-20 Hz, for example, of 10 Hz. The laser pulses can, for example, be synchronized with a movement of the sample in a spatial pattern to allow a mapping of a selected surface area for imaging mass spectrometry to occur. The energy of the laser beam can also be varied. The laser parameters should be selected by a skilled person so that the laser ablation process takes place for a particular sample effectively, thereby generating an ablated sample material that can be effectively transported to the atmospheric pressure ion source that generates an ionized species from the ablated sample material. The spatial resolution of the laser sampling can, for example, be selected in a wide range between <1 μm up to 1000 μm by changing the spot size of the laser beam at the surface of the sample. This can, for example, be performed via at least one optical device within the beam such, via an aperture and/or via focusing optics. In an embodiment, the laser may be a frequency quintupled Q-switched Nd:YAG laser operated at 213 nm and focused to spot sizes between 5 and 300 μm in diameter such as the LSX-213 (CETAC Inc., Omaha, Nebr., USA).

In an embodiment of the present invention, the laser ablation sampler can, for example, further comprise a positioning device configured to position at least one of the laser and the sample so that the laser can irradiate and ablate the material from the sample at least at one desired local removal site within the laser ablation chamber.

In an embodiment of the present invention, the positioning device can, for example, be at least one of a laser beam focusing and manipulation unit and a stage which can, respectively, be configured to move the sample.

A volume of the sample subjected to radiation from the laser will interact with the laser beam and the energy absorbed from the laser beam so that, by rapid heating, a material from the interacting area will be released from the surface and expand into the ambient atmosphere as a mixture of gas, molten droplets, and small particulate matter, which together constitute the ablated sample material. The composition of the ablated sample material and the distribution of the ablated sample material within the different phases (gas, molten, particles) depend on the composition and structure of the original sample, the laser parameters (wavelength, pulse duration, energy density etc.) and the atmosphere within the laser ablation chamber. Ambient conditions for the laser ablation can be controlled by selecting a composition of a gas within the laser ablation chamber, its pressure, temperature and/or flow. In an embodiment of the present invention, the laser ablation chamber can, for example, further comprise a gas inlet port and a gas outlet port. The gas inlet port can, for example, be configured so that a flow of a gas can be applied to the gas inlet port to control an atmosphere within the laser ablation chamber with respect to a gas composition and/or a gas pressure. The gas outlet port can, for example, be configured so that the flow of the gas through the laser ablation chamber transfers the ablated sample material towards the atmospheric pressure ionization source via the transfer line. The gas used should be selected to support the ablation process and the formation of the ablated sample material so that it is transportable towards the ion source and supports, or does not interfere, with the ionization processes taking place at the ion source. In an embodiment of the present invention, a noble gas such as nitrogen can, for example, be used as the gas within the laser ablation chamber.

In an embodiment of the present invention, the laser ablation chamber can, for example, further comprise internal structures which divide an area for samples from an area surrounding a sampling position.

In an embodiment of the present invention, a gas mixture can, for example, be added to a feeding gas of the atmospheric pressure ionization source which at least one of supports and enhances an ionization efficiency of the ablated sample material, or for a target analyte.

In an embodiment of the present invention, the apparatus can, for example, further comprise compounds which are fed to the atmospheric pressure ionization source via a solution nebulization to at least one of support or enhance an ionization efficiency, for a target analyte, and/or for a calibration.

In an embodiment of the present invention, the apparatus can, for example, further comprise a venturi pump configured to be driven by an operating gas of the atmospheric pressure ionization source. The gas of the laser ablation chamber is thereby sucked via the venturi pump into the atmospheric pressure ionization source.

In an embodiment of the present invention, the laser ablation chamber can, for example, further comprise a sample introduction port configured to automatically change the sample in the laser ablation chamber.

In an embodiment of the present invention, the mass spectrometer can, for example, be at least one of a quadruple mass spectrometer, a multipole mass spectrometer, a hexapole mass spectrometer, an octopole mass spectrometer, an ion-trap mass spectrometer, a time-of-flight mass spectrometer, a Fourier transform ion cyclotron resonance mass spectrometer, a sector field mass spectrometer, and an orbitrap mass spectrometer.

The present invention also provides a method of analyzing a sample using the apparatus as recited above. The method includes providing a sample in the apparatus. A material from the sample is ablated with the laser so as to provide the ablated sample material as an aerosol. A flow of a gas is applied to transport the ablated sample material to the atmospheric pressure ionization source. A species from the ablated sample material is ionized via the atmospheric pressure ionization source. The desorbed and ionized species is introduced into the mass spectrometer. The ionized species is separated by its mass-to-charge ratio.

In an embodiment of the present invention, the method can, for example, further comprise preforming a first pre-ablation to remove a cover material from a sample site covering the material to be analyzed. Chemical composition information for a subsurface material can thereby be obtained. This can be used to generate chemical composition depth profiles and/or even 3-D chemical composition maps.

In an embodiment of the present invention, laser parameters of the first pre-ablation can, for example, be different from laser parameters for an analytical sampling.

In an embodiment of the present invention, the method can, for example, further comprise characterizing a composition of the ablated sample material due to its mass-to-charge ratio.

In an embodiment of the present invention, the method can, for example, further comprise rasterizing across the sample with the laser to map a sample composition for imaging mass spectrometry. The laser thereby changes the location of an irradiated part of the sample. Changing the irradiated spot can also, for example, be realized by moving the sample relative to the laser beam, by moving the laser across the sample, and/or by guiding the beam towards different sample locations.

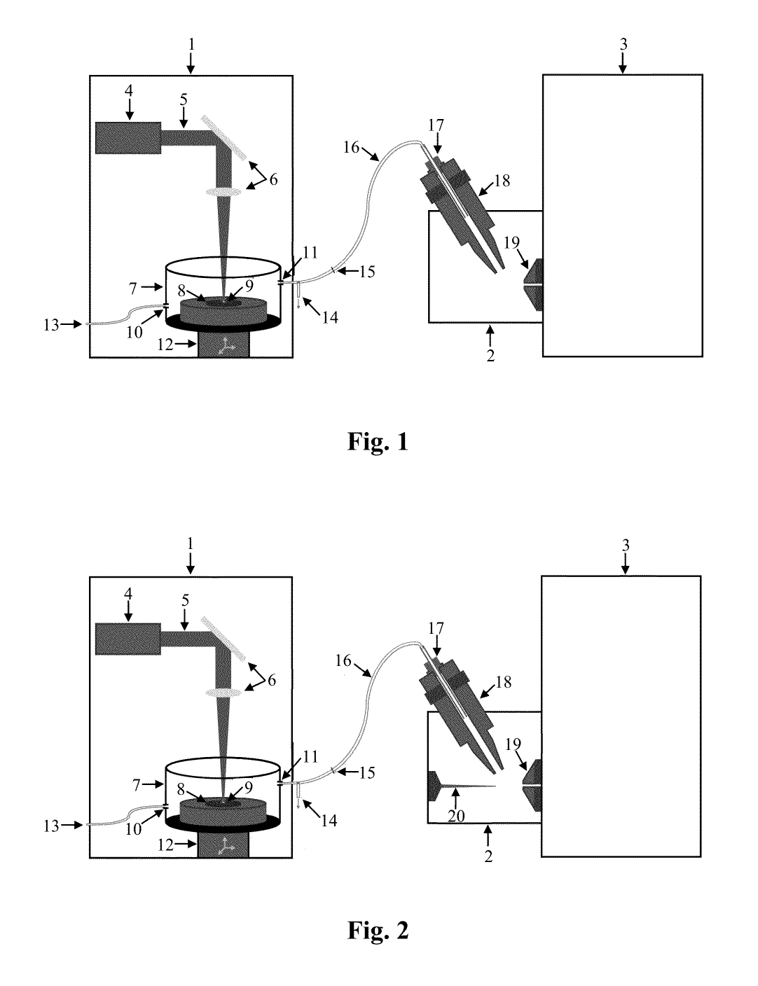

The apparatus and various embodiments will hereafter be described under reference to FIGS. 1 and 2. FIG. 1 shows a schematic diagram of the laser ablation atmospheric pressure post ionization mass spectrometry (LA/API-MS) setup. The apparatus for mass spectrometry comprises a laser ablation sampler (1), an atmospheric pressure ionization (API) source (2) and a mass spectrometer (3). The laser ablation sampler (1) further includes a laser ablation chamber (7) placed on an xyz-stage (12). The stage (12) allows the sample (8) to be moved below the laser beam (5) in any direction so that any location of the sample (8) placed within the laser ablation chamber (7) can be irradiated by the laser (4) to form an ablated sample material (9). The laser (4) generates a laser beam (5) which can be focused onto a surface of the sample (8) by laser beam focusing and manipulation units (6). These are optical devices (6) in the shown embodiment. By interaction of the laser beam (5) focused onto the sample surface, material is irradiated at the surface of the sample (8), thereby forming an ablated sample material (9) as an aerosol which is removed from the sample surface by spreading into the atmosphere of the laser ablation chamber (7).

A sample mapping can be realized by the xyz-stage (7) which, for example, moves the laser ablation chamber (7) with the sample (8) relative to the laser beam (5) in any direction so that any location of the sample (8) placed within the laser ablation chamber (7) can be irradiated by the laser (4) to form an ablated sample material (9). The laser (4) can be operated in a pulsed mode, whereby the laser pulses are synchronized with the movement of the sample (8) in a spatial pattern so as to allow the mapping of a selected surface area for imaging mass spectrometry.

The ablated sample material (9) is transported out of the laser ablation chamber (7) towards the atmospheric pressure ion source (2) via the transfer line (16), which connects the laser ablation sampler (1) with the ion source. The ablated sample material (9) is transported by a gas flowing through the laser ablation chamber (7), and exits the laser ablation chamber (7) through the gas outlet port (11). An embodiment of the present invention includes a device (15), which is a particle filter (15) in the shown embodiment, to separate larger particles out of the sample stream flowing towards the ion source that otherwise would not effectively be ionized, but would much rather act as a contaminant. A further embodiment of the present invention provides a multi-way valve or gas wasting channel (14) which is used to either direct the sample flow towards the atmospheric pressure ionization source (2) or direct it to a wasting channel. An ablated sample material (9) which is not intended for analysis by the mass spectrometer can thereby be routed away from the atmospheric pressure ionization source (2).

The ablated sample material (9) transported towards the atmospheric pressure ionization source (2) via the transfer line (16) is fed into the atmospheric pressure ionization source (2) via a connection unit or sample input channel (17). The ablated sample material (9) entering the atmospheric pressure ionization source (2) interacts to form an ion population having a mass-to-charge ratio distribution. In an embodiment of the present invention, the transfer line (16) may be a polyamide (PA) tubing of 2 m length. This allows for a relatively distant placement of the laser ablation sampler (1) in relation to the mass spectrometer (3).

In an embodiment shown in FIG. 2, the ion source is an ambient pressure chemical ionization (APCI) source. The embodiment in FIG. 2 also shows a corona discharge needle (20).

The mass spectrometer (3) is operably connected to the atmospheric pressure ionization source (2) via the mass spectrometer entrance (19) so that the ion population generated by the atmospheric pressure ionization source (2) is transmitted to the mass spectrometer (3). The mass spectrometer (3) separates the ion population according to their mass-to-charge ratio. The mass spectrometer (3) can, for example be a high resolution mass spectrometer which supports the identification of compounds by its exact mass.

The connection of the laser ablation sampler with a typical mass spectrometer provides several features. Both parts of the apparatus do not need to be incorporated into a single instrument, but can be placed relatively distant to each other. An ablated sample material can be transported through the transfer line across a relative long way in the meter range. A contact closure or transistor-transistor-logic trigger signal can further be used to synchronize the ablation process and data acquisition. The position of the laser beam on the sample can directly be used to map the corresponding intensities of the different mass-to-charge (m/z) ratios. Ionization efficiency for the ablated sample material by atmospheric pressure ionization sources, such as the APCI, is relatively high, thereby providing a meaningful sensitivity in analysis. The present invention has the distinct advantage over previously mentioned MALDI and LA based techniques in that no solvent or matrix is required that limits the applicability to certain target compounds and samples. The washing effect which reduces the obtained spatial resolution in those techniques is thereby avoided. Initial attempts to characterize the obtainable spatial resolution of the present invention indicate that the obtainable spatial resolution is only limited by the laser spot size and the concentration of the target analytes.

### EXAMPLES

The following examples are provided to illustrate particular features of working embodiments.

Pure nitrogen was used in these exemplary experiments to purge the laser ablation chamber and to transfer the ablated samples towards the atmospheric pressure ionization source. Polyamide (PA) tubing (4×1 mm) of 1 m length was used as the transfer line connecting the laser ablation sampler and the atmospheric pressure ionization source. An APCI source (Thermo Fisher Scientific) with a discharge current of 3 μA was used for post-ionization. The atmospheric pressure ionization source was connected to a high-resolution mass spectrometer (Exactive HCD, Thermo Fisher Scientific) operated in the positive ion mode with a full scan from m/z 100 to m/z 500. The laser ablation sampler used was a LSX-213 (CETAC Inc., Omaha, Nebr., USA). The laser spot size was 200 μm and the laser energy was adjusted to 10% of the maximum energy. The scan rate was 100 μm/s in the y direction while the laser was operated at a repetition rate of 10 Hz.

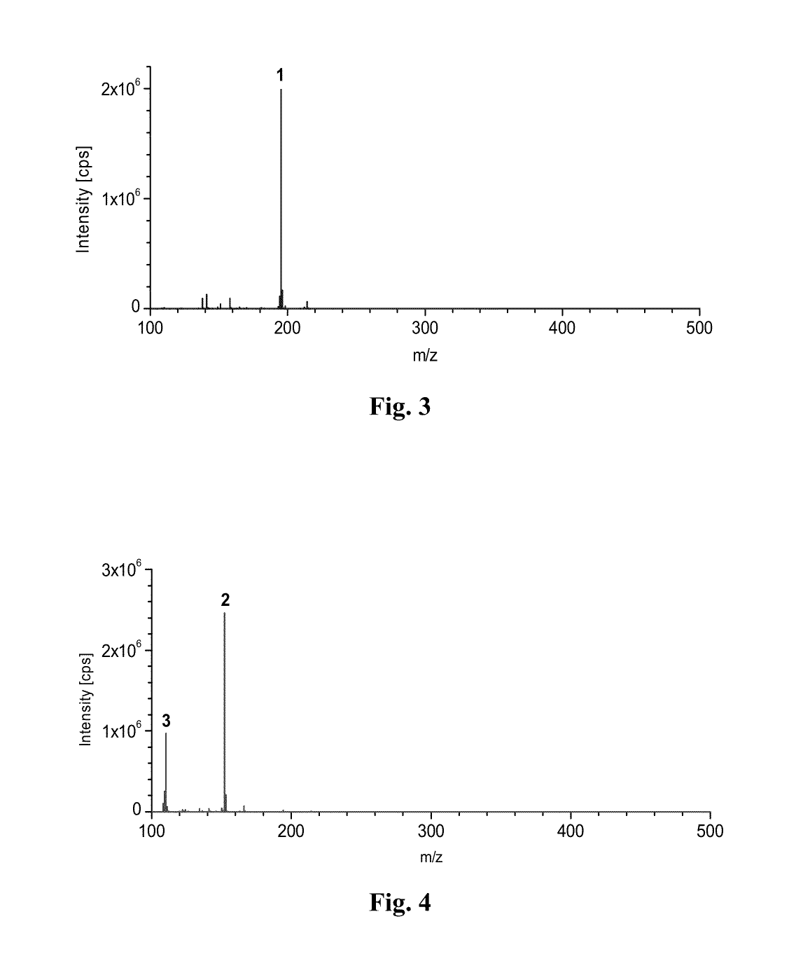

FIGS. 3 and 4 investigated the type of target analytes detectable and the fragmentation experienced through the combination of laser ablation and APCI post-ionization. Small droplets of 2 μL solutions containing 200 pmol of caffeine (FIG. 3) or acetaminophen (FIG. 4) dissolved in water were dosed onto glass carriers and dried. The dried droplets were sampled by the laser ablation sampler by selecting the dried spots as a sampling area (single line scans, 10% laser energy, spot size 200 μm, laser shot frequency 10 Hz, scan rate 50 μm/s). The obtained mass spectra (background subtracted) shown in FIGS. 3 and 4 clearly indicate that a meaningful sensitivity is obtained for the two compounds and that only little fragmentation occurs for these compounds. In FIG. 3, 1: caffeine, MH⁺, m/z 195.0887, δ=2.1 ppm. In FIG. 4, 2: acetaminophen, MH⁺, m/z 152.0706, δ=2.0 ppm; 3: aminophenol, MH⁺, m/z 110.0606, δ=4.5 ppm.

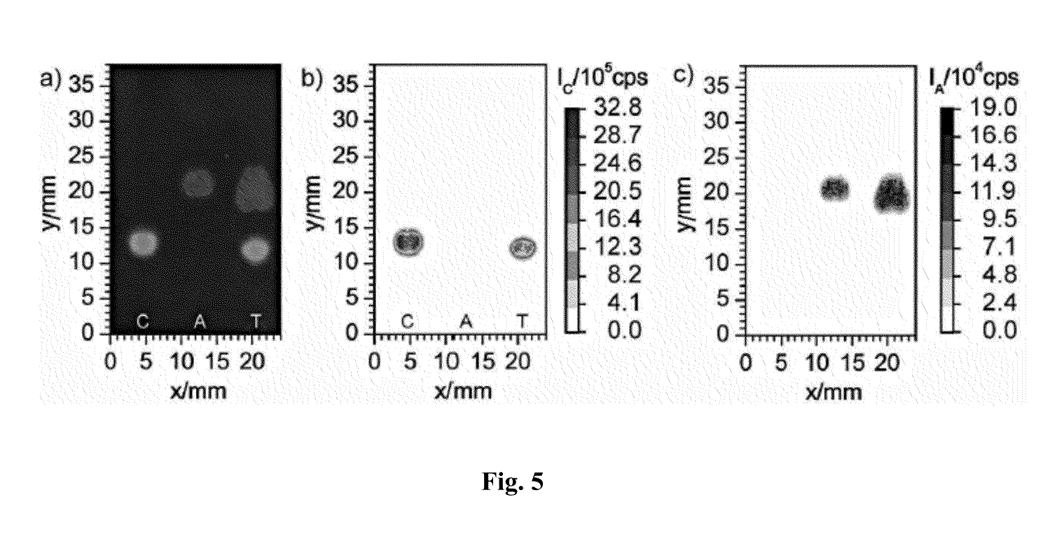

FIG. 5 illustrates the capabilities of the present invention with respect to mapping chemical compounds being separated by thin-layer chromatography (TLC). The TLC separation was carried out on the TLC plate TLC Silica gel 60 F₂₅₄ (Merck). The samples were separated in two development steps. The first mobile phase contains cyclohexane (86 v %), acetic acid (7 v %) and chloroform (7 v %). The second mobile phase contains cyclohexane (59 v %), methanol (6 v %), acetic acid (6 v %) and ethyl acetate (29 v %). Three samples were applied: caffeine standard (starting point: x=4 mm, y=−2 mm), acetaminophen standard (starting point: x=12 mm, y=−2 mm) and a Thomapyrin tablet (starting point: x=21 mm, y=−2 mm)). In FIG. 5, a) shows a fluorescence image obtained by an inverted digital fluorescence microscope (Keyence BZ-9000E) operated at an excitation wavelength of 470 nm and a fluorescence emission wavelength of 535 nm. FIG. 5, b) shows the ion image for m/z 195.084-195.092 (caffeine MH⁺) and c) shows the ion image for m/z 152.068-152.073 (acetaminophen MH⁺). The ion images were obtained by LA/APCI-MS. The TLC plate was ablated with a laser at 213 nm. The laser spot size was 200 μm and the laser energy was adjusted to 10% of the maximum energy. The scan rate was 100 μm/s in y direction while the laser was operated at a repetition rate of 10 Hz. Post ionization was carried out by APCI with a discharge current of 3 μA. The mass spectrometer was operated in the positive ion mode with a full scan from m/z 100 to m/z 500. The ablated sample was transported from the ablation chamber to the APCI source by a nitrogen flow through PA tubing (4×1 mm). The spots for the two compounds clearly identified by LA/APCI-MS spatially correlate with spots visualized by means of fluorescence.

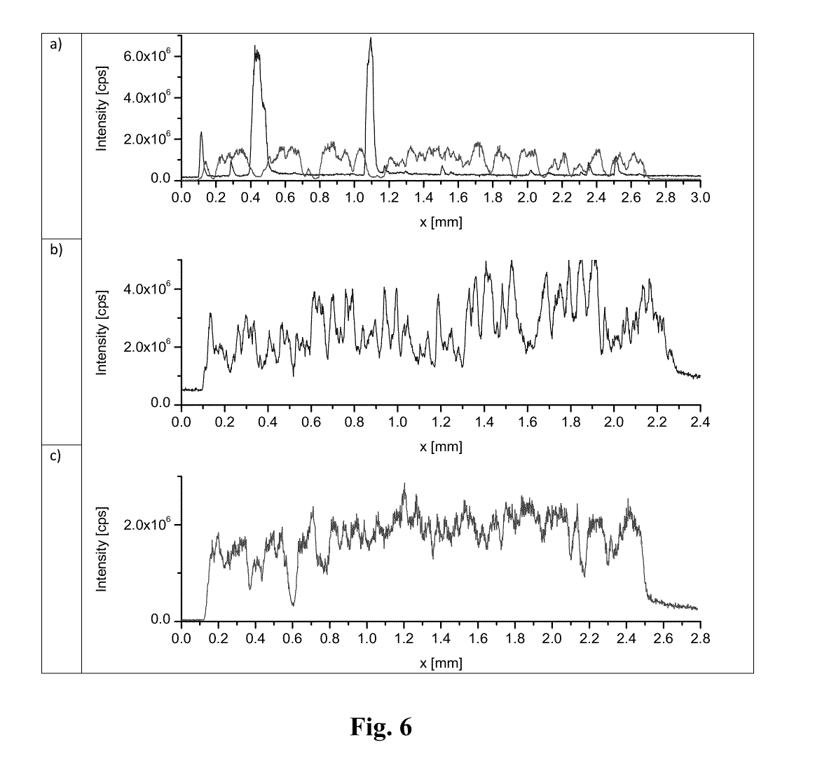

FIG. 6 illustrates the direct analysis of different active compounds from pharmaceutical tablets. Three different pharmaceutical tablets were placed within the laser ablation chamber without any sample preparation: a) Thomapyrin Classic (Boehringer Ingelheim GmbH & Co. KG), b) Coffeinum N 0.2 g (Mylan dura GmbH) and c) Paracetamol-ratiopharm 500 (Ratiopharm GmbH)). The tablet surface was sampled by laser ablation using a wavelength of 213 nm. The laser spot size was 25 μm and the laser energy was adjusted to 10% of the maximum laser energy. The scan rate was 20 μm/s in x direction while the laser was operated at a repetition rate of 20 Hz. Post ionization was carried out by APCI with a discharge current of 3 μA. The mass spectrometer was operated in the positive ion mode with a full scan from m/z 100 to m/z 1000. The ablated sample was transported from the ablation chamber to the APCI source by a nitrogen flow through PA tubing (4×1 mm). The signal traces in FIG. 6 a)-c) show the extracted ion traces for m/z 195.084-195.092 (caffeine MH⁺, black) and for m/z 152.068-152.073 (acetaminophen MH⁺, grey) obtained by LA/APCI-MS analysis of the tablet surfaces. The traces clearly indicate that the obtained sensitivity is highly sufficient to determine the active components directly from the solid tablet samples. The traces in FIG. 6 a) also show that different compounds might have different spatial distribution, which would be expected because often a tablet is a heterogeneously pressed powder consisting of different solid constituents.

Coupling laser ablation with an ambient pressure ion source such as the APCI was found to be very effective in performing molecular mass spectrometry directly from the surface of solid samples. Rasterizing the sample surface with the laser ablation sampler allows for molecular imaging mass spectrometry, whereby the obtainable spatial resolution is not hampered by blurring effects created through the use of solvents or matrix but only dictated by the laser spot size used. In addition to imaging, laser ablation also allows for the depth profiling of samples allowing for the analysis of layered materials such as coated tablets. Many advantages of the present invention arising from the various features of the apparatus and methods are described herein. Alternative embodiments of the apparatus and methods of the present disclosure may not include all of the features described above, yet still benefit from at least some of the features.

The present invention is not limited to embodiments described herein; reference should be made to the appended claims.

1. An apparatus for mass spectrometry, the apparatus comprising:
a laser ablation sampler comprising a laser ablation chamber and a laser configured to produce a laser beam, the laser ablation chamber being configured so that the laser can irradiate and ablate a material from a sample placed within the laser ablation chamber so as to generate an ablated sample material;
a transfer line;
an atmospheric pressure ionization source configured to generate an ion population, the atmospheric pressure ionization source being operatively connected to the laser ablation chamber via the transfer line so that the ablated sample material is transportable to the atmospheric pressure ionization source;
a mass spectrometer operatively connected to the laser ablation chamber and to the atmospheric pressure ionization source,
wherein,
the ablated sample material interacts with the atmospheric pressure ionization source to generate the ion population having a mass-to-charge ratio distribution,
the ion population is transmitted to the mass spectrometer, and
the mass spectrometer provides information on the mass-to-charge ratio distribution of the ion population.

2. The apparatus as recited in claim 1, wherein the interaction of the ablated sample material with the atmospheric pressure ionization source releases and ionizes atoms or molecules from the ablated sample material so as to generate the ion population.

3. The apparatus as recited in claim 1, wherein the atmospheric pressure ionization source is an atmospheric pressure chemical ionization, an atmospheric pressure photoionization, an atmospheric pressure laser ionization, an electrospray ionization, or a corona-type discharge source.

4. The apparatus as recited in claim 1, wherein the laser operates in at least one of a ultra-violet wavelength range, an infrared wavelength wave, and in a visible wavelength range.

5. The apparatus as recited in claim 1, wherein the laser further comprises a pulsed mode of emission operating in a femtosecond range, a picosecond range, or in a nanosecond range.

6. The apparatus as recited in claim 1, wherein the laser ablation sampler further comprises a positioning device configured to position at least one of the laser and the sample so that the laser can irradiate and ablate the material from the sample at least at one desired local removal site within the laser ablation chamber.

7. The apparatus as recited in claim 6, wherein the positioning device is at least one of a laser beam focusing and manipulation unit and a stage which are respectively configured to move the sample.

8. The apparatus as recited in claim 1, wherein the laser ablation chamber further comprises a gas inlet port and a gas outlet port, the gas inlet port being configured so that a flow of a gas can be applied thereto to control an atmosphere within the laser ablation chamber with respect to a gas composition and a gas pressure, and the gas outlet port being configured so that the flow of the gas through the laser ablation chamber transfers the ablated sample material towards the atmospheric pressure ionization source.

9. The apparatus as recited in claim 1, wherein the laser ablation chamber further comprises internal structures which divide an area for samples from an area surrounding a sampling position.

10. The apparatus as recited in claim 1, wherein a gas mixture is added to a feeding gas of the atmospheric pressure ionization source which at least one of supports and enhances an ionization efficiency of the ablated sample material, or for a target analyte.

11. The apparatus as recited in claim 1, further comprising compounds which are fed to the atmospheric pressure ionization source via a solution nebulization to at least one of support or enhance an ionization efficiency, for a target analyte, or for a calibration.

12. The apparatus as recited in claim 1, further comprising a venturi pump configured to be driven by an operating gas of the atmospheric pressure ionization source, wherein the gas of the laser ablation chamber is sucked via the venturi pump into the atmospheric pressure ionization source.

13. The apparatus as recited in claim 1, wherein the laser ablation chamber further comprises a sample introduction port configured to automatically change the sample in the laser ablation chamber.

14. The apparatus as recited in claim 1, wherein the mass spectrometer is at least one of a quadruple mass spectrometer, a multipole mass spectrometer, a hexapole mass spectrometer, an octopole mass spectrometer, an ion-trap mass spectrometer, a time-of-flight mass spectrometer, a Fourier transform ion cyclotron resonance mass spectrometer, a sector field mass spectrometer, and an orbitrap mass spectrometer.

15. A method for analyzing a sample using the apparatus as recited in claim 1, the method comprising:
providing a sample in the apparatus;
ablating a material from the sample with the laser so as to provide the ablated sample material as an aerosol;
applying a flow of a gas to transport the ablated sample material to the atmospheric pressure ionization source;
desorbing and ionizing a species from the ablated sample material via the atmospheric pressure ionization source;
introducing the desorbed and ionized species into the mass spectrometer; and
separating the ionized species by its mass-to-charge ratio.

16. The method as recited in claim 15, further comprising preforming a first pre-ablation to remove a cover material from a sample site covering the material to be analyzed.

17. The method as recited in claim 15, wherein laser parameters of the first pre-ablation are different from laser parameters for an analytical sampling.

18. The method as recited in claim 15, further comprising characterizing a composition of the ablated sample material from the mass-to-charge ratio.

19. The method as recited in claim 15, further comprising generating at least one of a chemical composition depth profile and a 3-D chemical composition map.
